(19) United States
(12) Patent Application Publication
(10) Pub. No.: US 2013/0191926 A1
(43) Pub. Date: Jul. 25, 2013

(54) Method and Apparatus for Streaming Rights-Managed Content Directly to a Target Device over a Network

(71) Applicants: Wing Hong Chow, Singapore (SG); Chee Wan Ng, Singapore (SG)

(72) Inventors: Wing Hong Chow, Singapore (SG); Chee Wan Ng, Singapore (SG)

(73) Assignee: EXPRESS IN MUSIC PTE LTD, Singapore (SG)

(21) Appl. No.: 13/876,067

(22) PCT Filed: Sep. 30, 2011
(86) PCT No.: PCT/SG2010/000364

§ 371 Date: Mar. 26, 2013

(51) Int. Cl. G06F 21/10

(52) U.S. Cl. CPC G06F 21/10
USPC 726/26

(57) ABSTRACT

A content server (120) can be coupled via the network (101) to a stream playing device (130), an input terminal (110), a content server or server (120) and a stream playing device (130), each being coupled to the network (101). The input terminal (110) may be configured with software or hardware features that enable a person having an account for a digital content service or a subscriber to select playback items located on the content server (120).

### FIELD OF THE INVENTION

The present invention relates generally to streaming multimedia content to a remote target device using a network. More specifically, the present invention is related to streaming rights-managed content to remote devices from a network accessible server.

### BACKGROUND

The infringing act of unauthorized duplication and of copyrighted musical works is a widespread problem. Copying or pirating musical works in many jurisdictions including, for example, Singapore, is a criminal offence and offenders may be prosecuted. Other less flagrant copyright violations are possible however and much more difficult to enforce, such as public performances of copyrighted works and the like. The copyright landscape for musical works, including derivative rights such as public performance rights and the like, can be quite complex and difficult to understand for even seasoned professionals, let alone ordinary individuals such as consumers or small business operators.

Copyright violations can ordinarily be addressed through a priori authorization and corresponding agreement as to the assessment of royalty payments. Compulsory royalties can be assessed afterwards for acts of previous infringement. However, understanding precisely how to assess royalties it is as difficult as identifying the often overlapping primary and derivative rights. For example, basic copyrights can cover areas such as a song title, album artwork, musical content and the like, and can include publishing, duplication, recording and performance rights. Within the copyright landscape, individual artists may be bound under recording contracts that specify allocations among artists and/or recording, companies for collaborative works. Further complicating the copyright landscape is that within each of the different areas, additional reproduction rights, performance rights and the like may be present.

It is not surprising then that the general public may not be aware that it is a violation of copyright law to play music from an original music CD in public without obtaining performance or public performance rights from the copyright owner. Such public performance rights become especially significant when musical works are played for commercial purposes in a public setting such as restaurants, karaoke venues, or other entertainment or retail venues where music is played. Still further, simple retailers or shop keepers, for example, may unknowingly infringe music copyrights by playing musical works inside retail shops using CD players to enhance the shop ambience.

While some venues have become aware of the need to seek permission and/or pay royalties for public broadcast or performance of musical works, others have not. One problem is that retailers are uncertain of what is or is not permitted under the copyright laws pertaining to the playback of copyrighted content, and receiving legal notice from the copyright owners of the musical works can be a shocking and unwelcome surprise. The negative publicity associated with being labelled an infringer of copyrights can affect business and may result in loss of customers and revenue.

Some schemes have been developed in an attempt to manage the distribution of copyrighted content from a source to, for example, a destination device. For example, in U.S. Patent Application Publication No. 2007/0005503 to Engstrom, et al. (Engstrom), a method is described for distributing digital media content. However, limitations are present in existing systems with regard to distribution to destination devices. For example, paragraph [0047] of Engstrom notes that a set-top media device is required, which must itself be proximally located within the wireless or wired communication range of the remote device. For users who desire flexibility in playback location, such constraints cause great inconvenience because, due to the need for proximity, a user cannot conveniently distribute digital media content to devices in remote locations that are not proximal to a set top box.

Further, if a retail outlet or outlets associated with a franchise, such as a popular coffee franchise, wishes to establish a musical content theme in various stores, that cater either to a franchise-wide content agenda or a store by store content agenda, or a combination of the above, individual store management of musical content is undesirable. In particular, the service staff of individual stores within a franchise are often preoccupied with daily activities and allocating the task of selecting and playing music can lead to problems, inefficiencies and inconsistencies of musical content from store to store and deviation from the musical content agenda. However, there are few solutions to allow management of the various issues associated with such content playback arrangements. It would be desirable for a system that could manage the copyrights associated with the musical or other copyrighted content while simplifying the delivery of the content through playback devices.

### SUMMARY

According to an embodiment, a method can be provided for streaming digital content over a network from a content server to a stream playing device. The method can include selecting a plurality of playback items located on the content server from an input terminal associated with an account. The input terminal can be coupled to the network and is different from the stream playing device such as being incorporated into a different device and provided at a different location or the like. The plurality of playback items can include digital content, such as music or audio, video content or the like, stored on the content server. Copyright permissions, such as permissions for public performance and the like, can be allocated to each of the plurality of playback items based on a parameter associated with the account. The selected plurality of playback items can be incorporated into a playback stream object based on an incorporation criteria. The playback stream object can be associated with the account.

It will be appreciated that a network can include a local area network, an Internet Protocol (IP) based network including wireless and wired networks, such as the Internet, WiFi, Global System for Mobile Communications, formerly known as Groupe Special Mobile, (GSM), General Packet Radio Service (GPRS), and more advanced third generation (3G) and fourth generation (4G) systems, evolutions and the like including any systems, combinations of systems, infrastructures, access technologies, interfaces, air interfaces, or the like referred to in the aggregate as the “cloud”. An account can include a mechanism for associating a paying client or customer including a person or a corporation or the like that can establish a subscription to particular digital content. In some instances, the account can be facilitated by an additional service account with a service provider that allows the person to access a network or a network service or have transactions with the service provider.

In an embodiment, a method can further include connecting the stream playing device and the server over the network and verifying that a device identifier code of the stream playing device is associated with the account. If the device identifier code of the stream playing device is associated with the account, the playback stream object including the plurality of playback items can be transferred from the content server to the stream playing device.

In an embodiment, the incorporation criteria can include one of a random incorporation criteria, a sequential incorporation criteria, a manually generated incorporation criteria, and a counter generated incorporation criteria. The incorporation criteria can include a condition or a set of conditions that can used to control playback of the playback items.

In an embodiment, the parameter associated with the account is determined by an account holder. For example, the parameter can be a subscription level associated with the account, a permission level associated with the account, or an individual royalty purchase associated with one of the plurality of playback items. The subscription level includes different categories or tiers or levels of subscription that entitle the account holder to different copyright permissions.

In an embodiment, the allocating copyright permissions can include subscribing to a use of the digital content, and allocating the copyright permissions to the based on the subscribed use of the digital content. The copyright permissions can include one or more of permissions for performance, recording, and publishing rights of the digital content. The copyright permissions can further include all permissions for performance, recording, and publishing rights of the digital content. The subscribing to the use can include subscribing to one of a private use and a commercial use of the digital content. The selecting a plurality of playback items can include accessing the content server from the input terminal through the network. The plurality of playback items can be selected from selectable playback items displayed on a user interface associated with the website. Accessing includes network accessing processes such as for example, accessing through a website, a direct connection from the input terminal, or through an application running on the terminal, or via a message exchanging facility. The access terminal can include a remote terminal, a laptop computer, a cellular telephone, a portable digital assistant (PDA), a smartphone, a reader, and the like.

In an embodiment, the selected ones of the plurality of playback items can constitute a first list of playback items. It should be noted however that the playback stream object is handled as a singular object by the stream playing device. Transferring the playback stream object can include transferring the playback stream object, for example as the above described singular object, while including the playback items constituted in the first list. The playback stream object can be stored in the stream playing device.

In an embodiment, the selecting the plurality of playback items can include one of the following, selecting a new at least one of the plurality of playback items, or deleting an existing at least one of the plurality of playback items. The newly formed object including the selected or deleted ones of the plurality of playback items constitute a second list of playback items. The second list of playback items can include the one of the selected new at least one and the deleted existing at least one of the plurality of playback items. Transferring the playback stream object can include transferring the playback stream object including the playback items constituted in the second list to the stream playing device. The playback stream object can be stored in the stream playing device. The transferring the playback stream object may further include comparing the first list and the second list. If one of at least portions of the playback stream object represent a difference between the first list and the second list, the stream playing device can either store or delete one of at least portions of the playback stream object.

In an embodiment, a stream playing device can be provided in a system for streaming digital content over a network from a content server. In the system, the content server and the stream playing device are connected to the network. The stream playing device can include a network interface coupled to the network, and a controller coupled to the network interface. The controller can include a buffer and a device identifier code capable of being associated with an account on the content server. The controller can be configured to connect with the server over the network interface and transfer the device identifier code. If the device identifier code is associated with the account, the controller can be configured to receive a playback stream object including a plurality of playback items from the content server. Each of the plurality of playback items can be associated with copyright permissions allocated based on a parameter associated with the account. The controller can be further configured to decode the playback stream object and output the digital content to an output device based on the copyright permissions, to track a number of the plays of individual ones of the plurality of the playback items associated with the output of the digital content, and the like. The output device can include one of an audio device, a visual device, and an audio-visual device. It will be appreciated that the controller and the network interface can be incorporated into an integrated circuit (IC), can be incorporated into a circuit board, can be incorporated into a hybrid circuit that includes a circuit board and an IC, or can be incorporated into a set top box.

In an embodiment, a server can be provided for streaming digital content over a network to a stream playing device. The server and the stream playing device can be connected to the network. The server can include a network interface configured to receive and send data over the network, a storage device including a content database that stores digital content including playback items, and a processor coupled to the network interface and the storage device. The processor can be configured to incorporate a selected plurality of the playback items into a playback stream object based on an incorporation criteria. The playback stream object can be associated with an account. When the server is connected with the stream playing device over the network interface, the server can receive a device identifier code from the stream playing device. If the device identifier code is verified to be associated with the account, the server can transfer the playback stream object including the plurality of playback items to the stream playing device. Each of the plurality of playback items are associated with copyright permissions allocated based on a parameter associated with the account. The server can include a World Wide Web interface to which the input terminal associated with the account can make a connection over the network interface.

In an embodiment, the parameter associated with the account can include one of: a subscription level associated with the account; a permission level associated with the account; and an individual royalty purchase associated with one of the plurality of playback items. The copyright permissions can be allocated based on a subscription to a use of the digital content, wherein the copyright permissions including performance, recording, and publishing rights of the digital content. The use can include one of a private use and a commercial use of the digital content. The selected plurality of playback items can include ones of the playback items selected by accessing the content server from the input terminal through the network, and/or selecting the plurality of playback items from selectable playback items displayed on a user interface associated with the input terminal. The accessing can include mechanisms for accessing a network such as accessing through a website, or through a direct connection from the input terminal, or through an application running on the terminal, or through a message exchanging facility. The selected ones of the plurality of playback items can be constituted according to a first list of playback items. The playback stream object can be transferred and can include the playback items constituted in or according to the first list. Further, the selected items, for example when one of a new at least one of the plurality of playback items and a deleted existing at least one of the plurality of playback items are involved, can be constituted in accordance with a second list of playback items. The processor can be further configured to transfer the playback stream object including the playback items constituted according to the second list.

### BRIEF DESCRIPTION OF THE DRAWINGS

In order that embodiments of the invention may be fully and more clearly understood by way of non-limitative examples, the following description is taken in conjunction with the accompanying drawings in which like reference numerals designate similar or corresponding elements, regions and portions, and in which:

FIG. 1A is a diagram illustrating an exemplary system for streaming digital content over a network from a content server to a stream playing device in accordance with one or more embodiments;

FIG. 1B is a diagram illustrating an exemplary playback stream object including playback items in accordance with one or more embodiments;

FIG. 1C is a diagram illustrating an exemplary playback stream object showing various playback time boundaries in accordance with one or more embodiments;

FIG. 1D is a diagram illustrating an exemplary system generating a new playback stream object in accordance with one or more embodiments;

FIG. 1E is a diagram illustrating an exemplary new playback stream object being compared with an existing playback stream object in accordance with one or more embodiments;

FIG. 2A to 2D are block diagrams illustrating an exemplary device for receiving streaming content in accordance with one or more embodiments;

FIG. 3 is a block diagram illustrating components of an exemplary device for receiving streaming content in accordance with one or more embodiments;

FIG. 4 is a flow chart illustrating a method for streaming digital content over a network from a content server to a stream playing device according to one or more embodiments;

FIG. 5A to FIG. 5C are a series of process flow diagrams illustrating a method for streaming digital content over a network from a content server to a stream playing device according to one or more embodiment;

FIG. 6 is a process flow diagram illustrating an exemplary interaction between a stream playing device and servers associated with content streaming in accordance with one or more embodiments;

FIG. 7 is a process flow diagram illustrating an exemplary interaction between a stream playing device and servers associated with content streaming in accordance with one or more embodiments; and

FIG. 8A to FIG. 8C are screen shots illustrating an exemplary user interface for content selection in accordance with one or more embodiments.

### DETAILED DESCRIPTION

While exemplary embodiments pertaining to the invention have been described and illustrated, it will be understood by those skilled in the technology concerned that many variations or modifications involving particular design, implementation or construction are possible and may be made without deviating from the inventive concepts described herein.

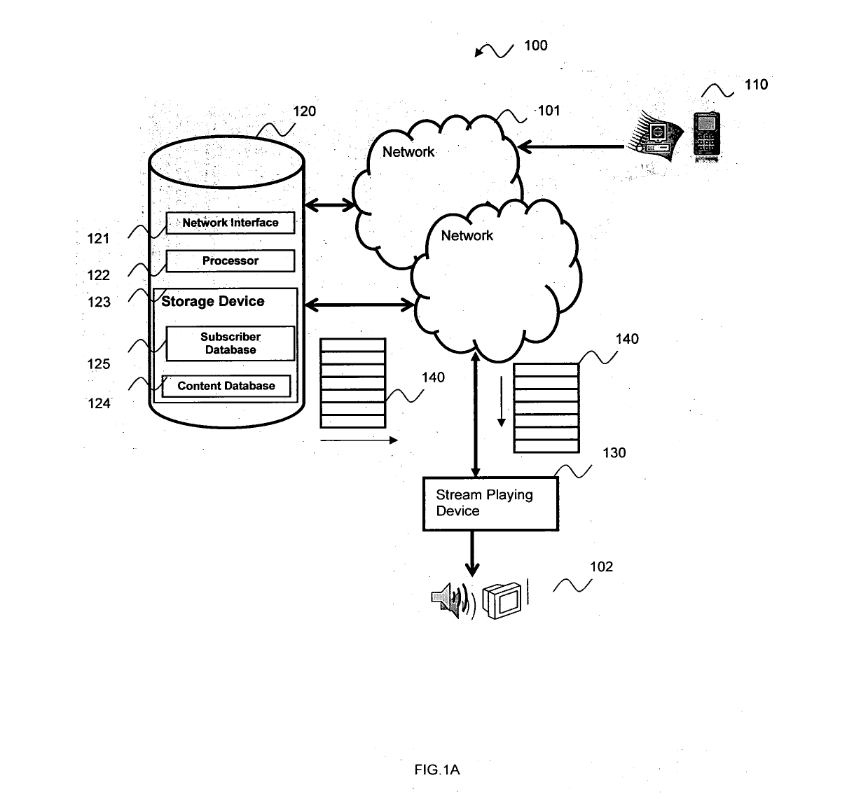

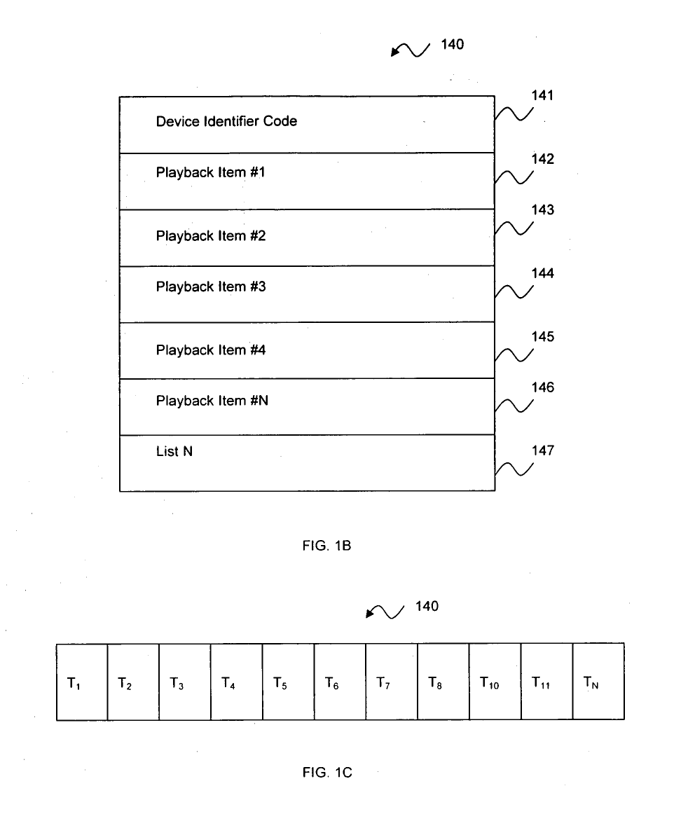

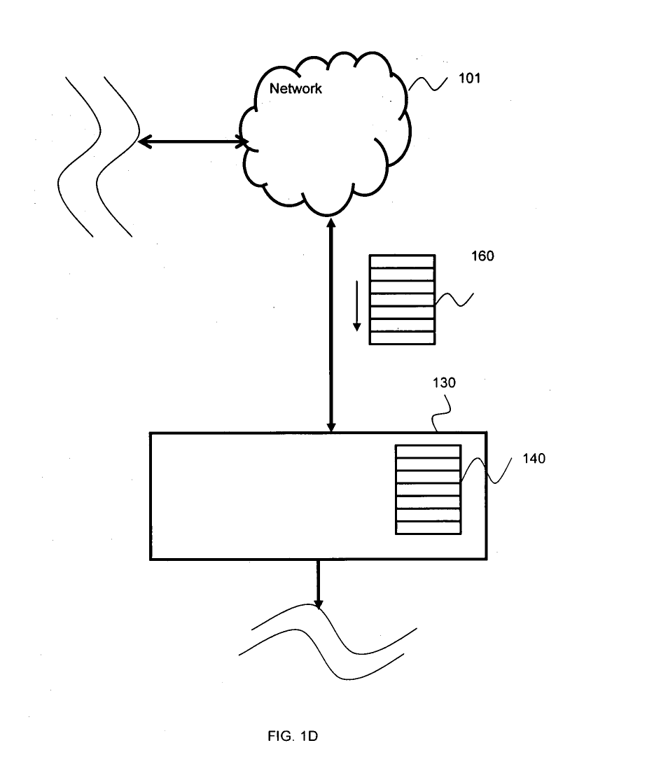

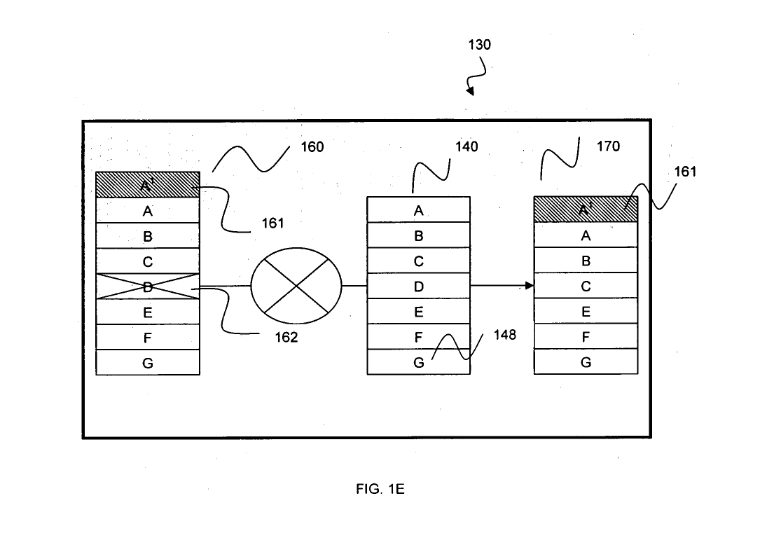

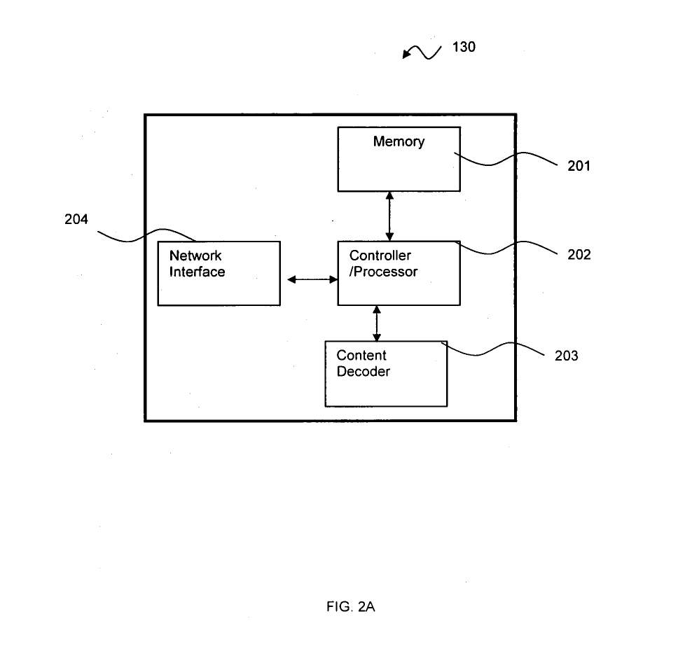

An exemplary system 100 can be configured for streaming digital content over a network 101 from a server such as a content server 120 to a stream playing device 130 in accordance with an embodiment such as is illustrated in FIG. 1A. The network 101 may be a network such as a GPRS network, a GSM network, the Internet, a local area network, or the like, or a combination of network, infrastructure and access elements that form what is known to those of skill in the art as the communications and computing “cloud”. The system 100 can include an input terminal 110, a content server or server 120 and a stream playing device 130, each being coupled to the network 101. The input terminal 110 may be configured with software or hardware features that enable a person associated with an account in a system for an exemplary digital content delivery service as described herein, such as an individual subscriber, a corporate subscriber or account holder or the like, to select playback items located on the content server 120.

The stream playing device 130 can be configured to receive the selected playback items from the content server 120 via the network 101 and output the selected playback items in an output format suitable for playback on an output device 102. The output format may be a digital audio format or digital video format that includes audio synchronization or, some other combination digital video/audio format. The digital audio format may include the commonly used and well known MP3 format, which itself was developed in connection with various MPEG video formats, WAV format, WMV format, OGG format, or the like. The output device 102 can be an audio device such as a speaker, an audio/visual device such as a television, a visual device such as a display that is specially adapted to process a playback stream object as will be described in greater detail hereinafter by, for example, inclusion of a specialized chip or circuit that is incorporated into the device itself or into a set top box or the like to which the device can be attached.

An embodiment of the server 120 is described as follows. As shown in FIG. 1A, the server 120 has a network interface 121 configured to receive and send data over the network 101, a storage device 123 including a content database 124 that stores digital content including playback items, and a processor 122 coupled to the network interface 121 and the storage device 123. The storage device 123 can also include a subscriber database 125 that stores information in relation with an account associated with the digital content service. The processor 122 is configured to incorporate a selected plurality of the playback items into a playback stream object 140 based on an incorporation criteria, the playback stream object 140 associated with an account. The processor 122 connects with the stream playing device 130 over the network interface 121 and receives a device identifier code from the stream playing device 130. If the device identifier code is verified to be associated with the account, the playback stream object 140 is transferred to the stream playing device 130.

As illustrated in FIG. 1B, the playback stream object 140 includes playback items such as playback item #1 142 through playback item #N 146 which can correspond to the selected plurality of playback items. The playback stream object 140 can optionally include a list N 147 and a device identifier code 141 that associates the stream with a destination device and includes a listing of the playback items included in the playback stream object. If will be appreciated that if the playback stream object is sent to multiple devices, multiple device identifiers can be used or the device identifier can be omitted. It will be appreciated that playback items 142-146 can be audio, video or other digital content. Each of the selected plurality of playback items in playback stream object 140 can be provided with copyright permissions allocated based on a parameter associated with the account. In accordance with FIG. 1C, it can be seen that the playback items can have reference information such as playback times T1-TN, or other information associated therewith such that the position of the playback items within the playback object can be known.

As shown in FIG. 1D, when a new selection of playback items is completed, a new object 160 can be sent, for example, from server 120 over network 101 to stream playing device 130. With reference to FIG. 1E, the existing playback stream object 140, for example, may include selections A, B, C, D, E, and F, while the new object 160 can include an additional playback item 161 and reflect a deletion of an existing item D at 162. The new object 160 and the existing object 140 can be compared and the resulting playback stream object 170 can, for example, be stored in the stream playing device 130.

The processor 122 can manage aspects of the packaging and delivery of content, the communications of the content, and other aspects such as account verification, playback count tallying, digital rights management (DRM), which includes the payment of royalties based on the playback tally, and the like. The processor 122 can manage, for example, the digital content service, the connectivity to the Internet, the digital content retrieval and the delivery of the streaming playback object 141 according to a streaming protocol, the interface for content management and statistic reporting, and can also provide the website interface and interaction with a search engine for digital content selection as well as hosting the database itself. For example, the processor 122 can include an algorithm for generating statistics to track each playback item for the frequency of selection, playback, or streaming to the stream playing device.

The information related to the generated statistics report can be used to facilitate a payment fee structure for the digital content service associated with back-end payment of royalties that are transparent to the subscriber and form one of the advantages of the invention. For example, the frequency of selection of a playback item can be used to calculate the royalties associated with the copyright permissions allocated to the selected playback item 141. Application programming interfaces (APIs) may also be provided for existing and future application development. In an embodiment, the processor 122 may be provided in an application server separate from the storage device 123. It should be noted that the storage device 123 provides and standardizes the content data structure. The storage device 123 may include a customer database and provide data redundancy. In an embodiment, the storage device 123 may be provided in a database server separate from the processor 122.

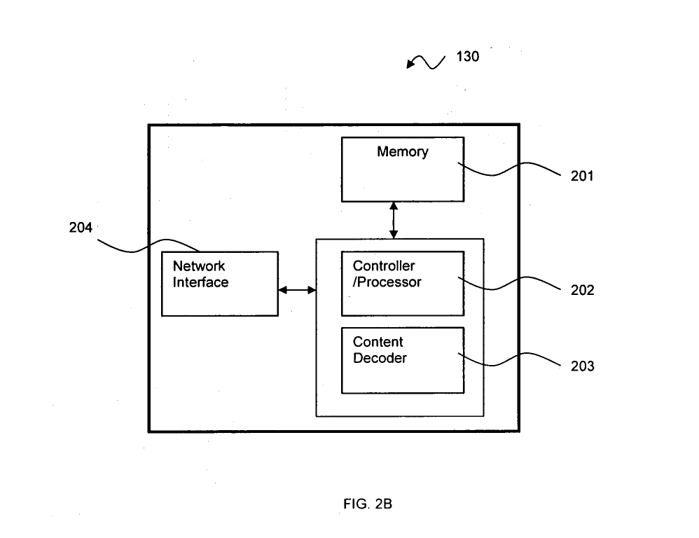

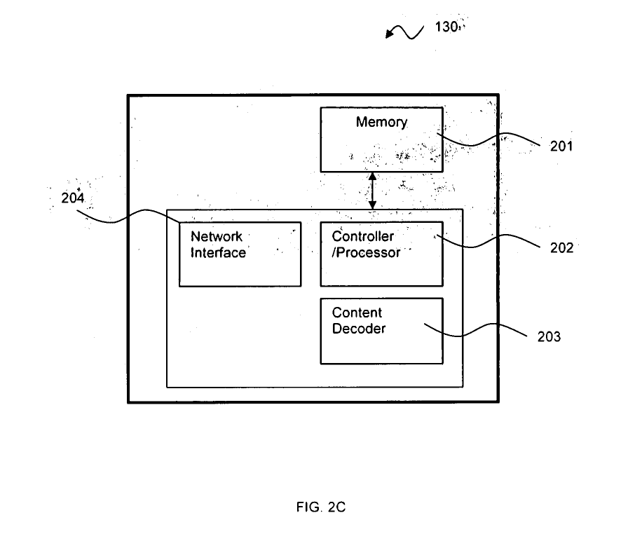

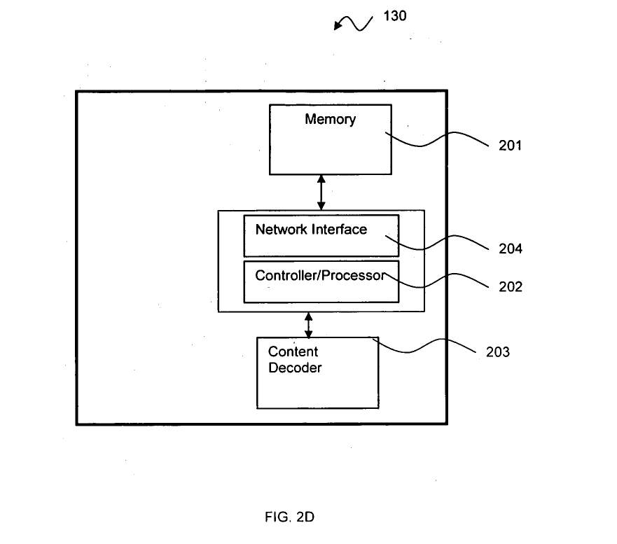

An embodiment of the stream playing device 130 is illustrated in further detail in FIG. 2A. The stream playing device 130 can have a network interface 204 for coupling to the network 101, and a controller 202 coupled to the network interface 204 for controlling the network interface 204 and interacting and transferring data to and from the server 120 over the network 101, and a content decoder 203 for decoding the data for playback or output to an output device 102. The controller 202 includes a buffer or memory 201 and can be provided with a device identifier code that can be associated at the server end with an account on the content server 120. During, for example, an initialization, verification, authorization session or the like, the controller 202 is configured to connect with the content server 120 over the network interface 204 and transfer the device identifier code. If the server 120 determines that the device identifier code is associated with the account, the controller 202 may receive a playback stream object 140 including a plurality of playback items 142-146 from the content server 120. Each of the plurality of playback items 142-146 are associated with copyright permissions allocated by the server 120 based on a parameter associated with the account.

The stream playing device 130 does not require a media player application to be invoked in order to stream the playback stream object to an output device because the controller 202 is configured to decode or process the received playback stream object into a data format for streaming. The stream playing device 130 may be powered through the power supply of the output device 102 through an adapter, such as a 5V adapter, or can be powered by batteries or other power source or the like. The components, i.e. the controller/processor 202, the memory 201, the network interface 204 and the content decoder 203 of the stream playing device 130 may be integrated into an IC chip, on a circuit board or in a module. Therefore, the stream playing device 130 can be compact and simple in design whether at a chip, circuit board or module level such as a set-top box or the like.

Alternatively, as shown in FIG. 2B, the controller 202 and the content decoder 203 are incorporated into an integrated circuit (IC), a circuit board or a module. Referring to FIG. 2C, the network interface 204, the controller 202, and the content decoder 203 are incorporated into an integrated circuit (IC), a circuit board or a module. Referring to FIG. 2D, the network interface 204, and the controller 202 are incorporated into an integrated circuit (IC), a circuit board or a module.

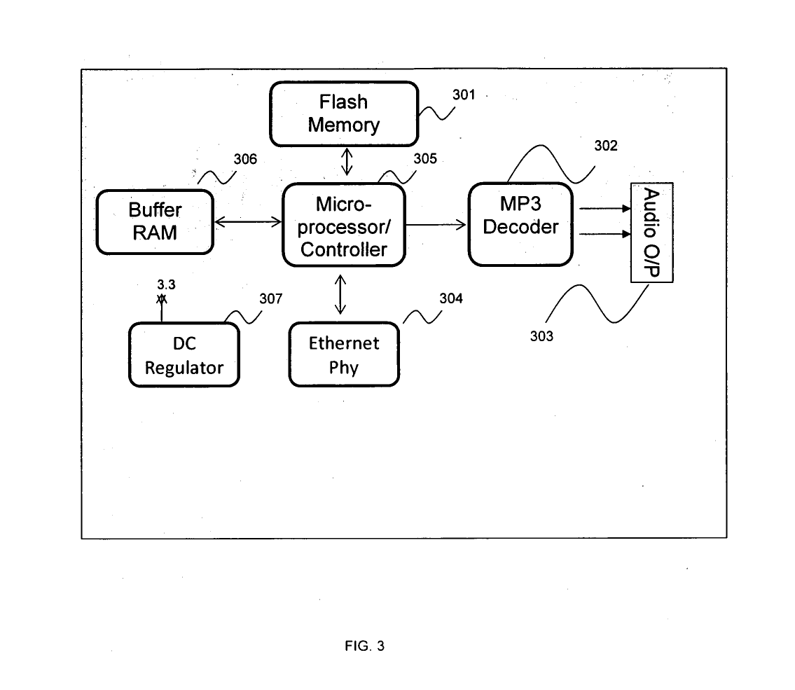

FIG. 3 illustrates components of an exemplary stream playing device 300 having a similar configuration to the stream playing device 130. Specifically, the stream playing device 300 has a network interface 304 coupled to the network 101 and a controller 305 coupled to the network interface 304. The controller 305 has a buffer 306 and a device identifier code capable of being associated with an account on the content server 120. The controller 305 is configured to perform the same operations as the controller 202 described above. In addition, the stream playing device 300 has a MP3 decoder 302 coupled to the controller 305 so as to decode the playback stream object and output the digital content to an output device 102 based on the copyright permissions allocated to the account. The stream playing device 130 or 300 may be a wired or wireless device and, accordingly, the network interface may be adapted to connect to network 101 according to wired or wireless access technology as would be appreciated by one of skill in the art. The controller 202 or 305 may be further configured to track a number of the plays of individual ones of the plurality of the playback items associated with the output of the digital content.

In an embodiment, the controller 202, 305 and the network interface 204, 304 may be incorporated into a set top box. Alternatively, the controller 202, 305, the network interface 204, 304, the memory (201, 301) and the content decoder (203, 302) may be incorporated into a set top box. The set-top box can be configured to be installed in the retail shop connecting to the Internet and the speaker system to be provided by the retailer. For example, the set-top box may include a unshielded twisted pair (UTP) for a wired Internet connection, speakers output and power input. Alternatively, the set-top box may include an optional module for internet connection such as a WiFi connection should there be no wired Internet connection in the retail shop. The set-top box receives digital content from the server 120 via the Internet and plays the digital content through an output device such as speakers in a format such as a MP3 format. The set-up box may be powered by the speakers through a 5V adaptor. Two light emitting diodes (LEDs) for indicating POWER and LINK may be provided at the front of the set-top box. The set-top box does not require a screen because the set-top box does not require a media player application to be invoked in order to stream the playback stream object to an output device. The set-up box may have an additional output for audio/video playback.

In an embodiment, the controller 202, 305 and the network interface 204, 304 may be incorporated into a circuit board. Alternatively, the controller 202, 305, the network interface 204, 304, the memory (201, 301) and the content decoder (203, 302) may be incorporated into a circuit board. The circuit board is described as follows. The circuit board performs similar operations to the set-top box. The circuit board may be integrated into electrical appliances like speakers, television, and cable TV set-top box, etc. The electrical appliances are coupled to the internet through the network interface of the circuit board. The circuit board may tap power from the electric appliances and output from the appliance speaker systems.

In an embodiment, the controller 202, 305 and the network interface 204, 304 may be integrated into an integrated circuit chip (IC chip). Alternatively, the controller 202, 305, the network interface 204, 304, the memory (201, 301) and the content decoder (203, 302) may be incorporated into an IC chip. The features as described herein in connection with the stream playing device 130, whether embodied in connection with a set-top box or as a stand alone device, may be incorporated into a circuit board, integrated in an integrated circuit (IC) chip, or may be incorporated into a hybrid circuit consisting of a circuit board and an IC chip. In the case of an IC chip, the chip may then be integrated in various hardware applications or may be incorporated in an existing electric circuit design or new developments in electric circuit designs. In an embodiment, the controller 202, 305 and the network interface 204, 304 may be integrated into an output device such as speakers, television, a music platform, or the like. By integrating the controller and the network interface into speakers, the requirement for a media source such as a CD player, USB input, SD card input, iPod connection, or the like is eliminated. Exemplary speakers incorporating an IC chip in accordance with embodiments, for example, can be coupled to the network by a wired connection such as a simple UTP-based Internet connection, or a wireless connection. For the subscriber who uses the speakers at home, the advantage is efficient use of space because he need not have two separate devices to play digital content or music content. Neither does he require cables to connect from the playback device such as a CD player or a computer to an output device such as speakers. A display such as a LCD screen may be integrated or connected to the speakers to display the list of playback items, preview songs and to administer the list of playback items.

In an embodiment, the controller 202, 305 and the network interface 204, 304 may be integrated in the television so that the television is coupled to the internet or the network 101. The television may incorporate an output for audio/video playback of the playback items. The television may have a user interface that enables a subscriber to use the television to login to the website on the content server 120 to administer the list of playback items 142-146. Once the list of playback items 142-146 is defined by the subscriber, the television user interface may be turned off. In other embodiments, the controller and 202, 305 and the network interface 204, 304 may be integrated on a licensed music platform or a portal for the future Internet TV appliance or audio/visual internet devices.

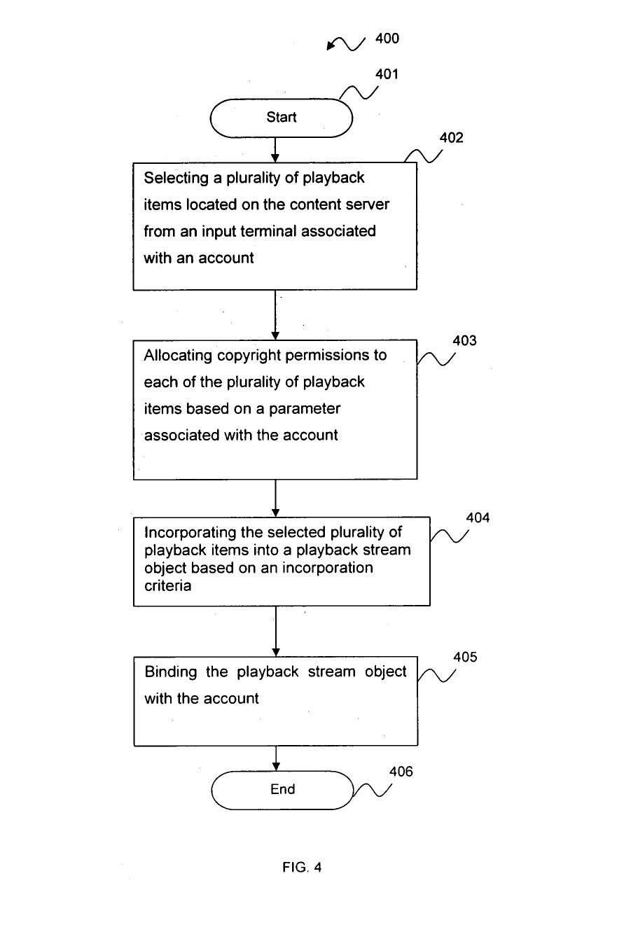

The method 400 illustrated in FIG. 4 can begin at 401, such as through an initialization process of the entire system or a specific module of function. A plurality of playback items located on the content server 120 can be selected from an input terminal associated with an account at 402. Based on a parameter associated with the account, copyright permissions are allocated to each of the plurality of playback items at 403. It will be appreciated that the parameter associated with the account may include a subscription level, a permission level, an individual royalty purchase associated with one of the plurality of playback items, or the like. The selected plurality of playback items are incorporated into a playback stream object based on an incorporation criteria at 404. The incorporation criteria can be used to determine, for example, the order, the update frequency or the like, in which playback items can be included or incorporated into a playback stream object. The incorporation criteria can therefore include criteria for random incorporation, sequential incorporation, manually generated incorporation, counter generated incorporation, and the like or some combination of the above. Alternatively, the incorporation criteria can include a counter generated criteria in combination with other criteria such as random incorporation, sequential incorporation, manually generated incorporation and the like. The playback stream object is associated with the account at 405 such that it can be transferred, for example, to various playback device associated with the account. While the method is indicated at 400 as ending, it will be appreciated by one of ordinary skill in the art that in practice, the procedure can loop, can be recalled, can be restarted, or the like.

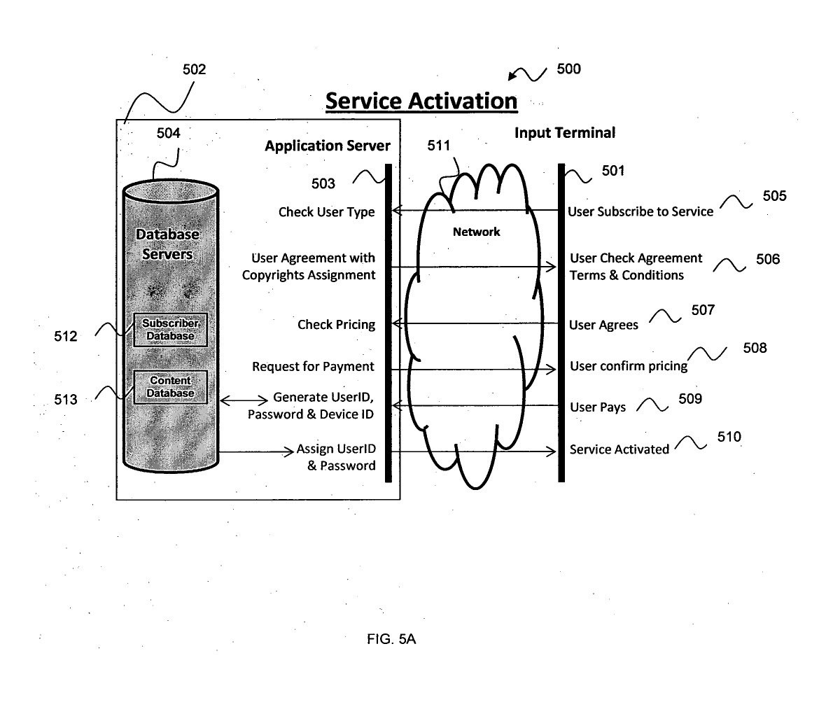

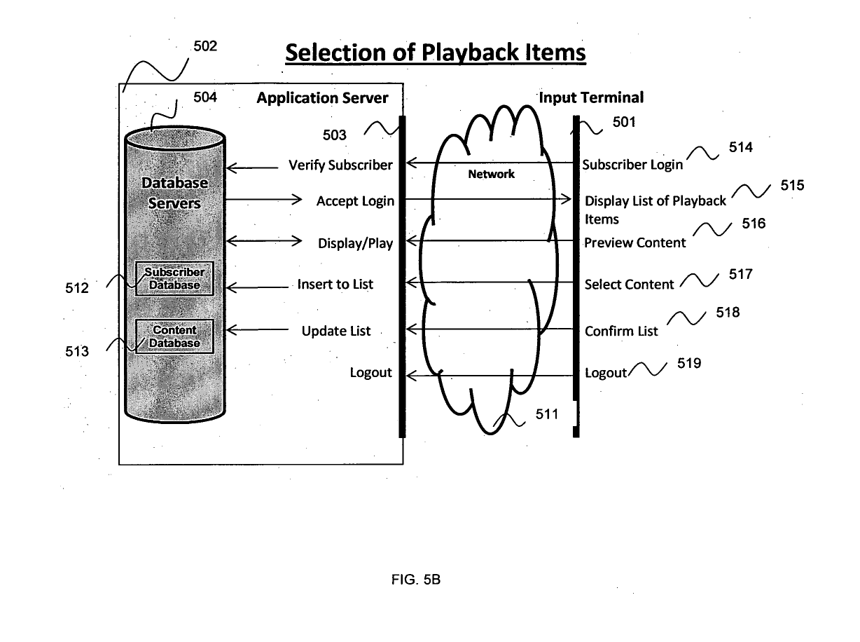

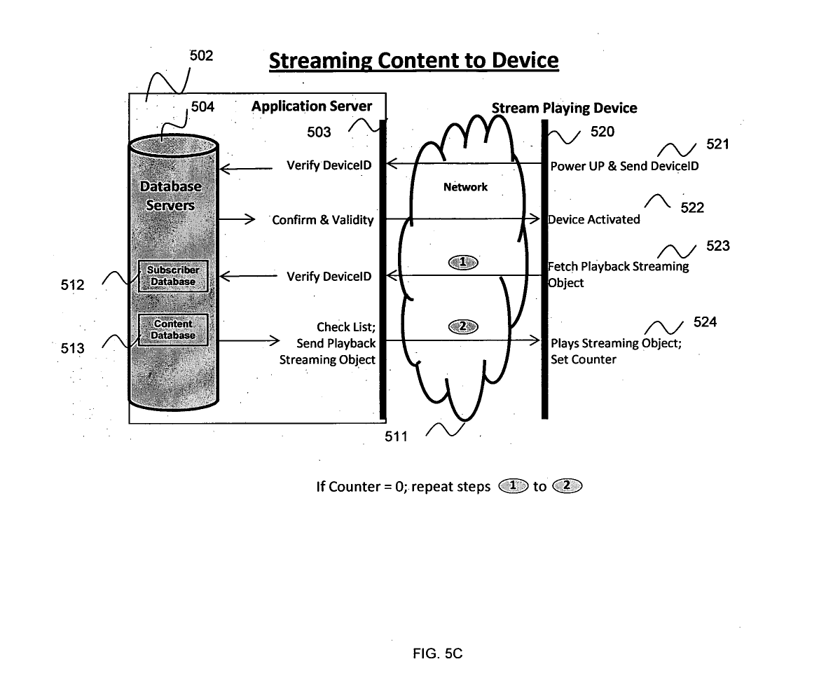

FIG. 5A to FIG. 5C illustrate various aspects and exemplary procedures for streaming digital content over a network from a content server to a stream playing device. FIG. 5A is a process flow diagram illustrating an exemplary interaction and process exchanges over a network 511 between an input terminal 501 and a content server 502 associated with service activation at 500 in accordance with an embodiment. The content server 502 has an application server 503 coupled to the network 511, and a database server 504 coupled to the application server 503. The database server 504 may have a subscriber database 512 for storing information related to a subscriber and a content database 513 for storing digital content. In exchange 505, a request associated with an account can be generated and sent to the application server 503, whereupon the application server 503 determines the copyright permissions required for the type of subscribed use indicated in the request. For example, the application server 503 may verify, based on input from a subscriber collected during the request that defines which consumer type the subscriber belongs to. Specifically, the application server 503 checks whether the subscribed use is a private use or a commercial use since the copyright permissions differ according to how the digital content is used. For example, a retail customer may require recording, publishing and performance rights for playing music in a retail space whereas a home customer may require significantly fewer rights.

In exchange 506, after the type of use is determined, the relevant copyright permissions are allocated each of the plurality of playback items or digital content based on the subscribed use of the digital contents. The allocated copyright permissions may be provided to the subscriber in an assignment agreement with copyrights assignment of the digital content to the subscriber. By allocating the copyright permissions based on the subscribed use of the digital contents, an advantage may be realized in that the home customer or the retail customer need not approach different copyright owners to obtain the relevant copyright permissions to use the digital content. The legal process associated with playing digital content is greatly simplified by establishing service with a single source.

In exchange 507, if the subscriber accepts the assignment agreement, the acceptance of the assignment agreement is sent to the application server 503 where it is then determined what the amount of payment required for the assignment of the copyright permissions will be. In the exchange at 508 the application server 503 sends a request to for payment to the subscriber, whereupon the subscriber can confirm the pricing. In the exchange at 509, the subscriber can make payment whereupon the application server 502 generates account information such as, an user ID, a password and a device identifier code for accessing the digital content service on the servers for the subscriber. In the exchange at 510, the account information is associated with the subscriber and the account for the digital content service is activated. It should be noted that the device identifier code can be known in advance and can be associated with one or more stream playing devices that are provided to the subscriber before service activation. The stream playing device may be installed in a designated location associated with the subscriber, such as a retail shop for streaming digital content for playback in the retail shop.

As noted, multiple device identifier codes can be associated with an account because more than one stream playing device can be deployed for a given account. For example in a chain of stores, each store can be provided with a stream playing device and the collective devices can be managed by a single representative such as a manager associated with the account. In other applications, the digital content service may be provided to an individual with a single device. In particular, for retailers, the digital content service offers a one-stop solution to provide externally managed public performances of music in a retail space. The features of the digital content service may include an up-to date complete library of song titles which covers all music copyrights for the song titles. For example, by having an account with the digital content service, the retailer may play music at an agreed rate, for example a flat monthly rate. To start an account or to subscribe to the digital content service, a customer may do so at an input terminal 501, such as by subscribing online or at a point of sale, whereby the details required for the account creation is entered on behalf of the customer online after a sale. Depending on the copyright licensing terms by the owners of the copyrights such as the music labels and publishers, the service may include unlimited digital content playback to the subscriber based on a one time payment fee or on a monthly subscription payment fee.

FIG. 5B is a process flow diagram illustrating an exemplary interaction and associated exchanges between an input terminal 501 and application server 503, and database server 504 associated with the process of playback item selection. As described above in connection with steps 509, 510, the login information such as an user ID, a password and a device identifier code is created for the subscriber upon activation of an account for the digital content service. In the exchange at 514, the subscriber may rely on the login information to submit a login request to a website hosted by the application server 503 in order to access the subscribed service. The login request may be submitted through an input terminal as described herein. Upon verifying that the login information is associated with a subscriber, the application server 503 accepts the login request. In the exchange at 515, during a login to the service, a list of playback items may be displayed in the input terminal. The list of playback items may be created based on preferences indicated during the service activation 500 or subscription process or may be selections based on previous interaction with the service for existing subscribers. In the exchange at 516, the subscriber may preview one or more playback items located on the database server 504 through the application server 503. At any time, the subscriber may also login to the website to preview the newly updated songs. In the exchange at 517, the subscriber selects one or more playback items to be inserted or deleted from the first list of playback items. In the exchange at 518, the list is updated and new list of playback items is created on the database server 504 upon confirmation of the changes such as insertion or deletion. The subscriber may then logout at 519 from the website. Each time changes are made to the playback items, the changes can be included in a new playback stream object that can be transferred to the stream playing devices associated with the account.

FIG. 5C is a process flow diagram illustrating an exemplary interaction and exchanges between a stream playing device 520 and the content server 502. The stream playing device 520 has a device identifier code. When the stream playing device 520 is powered and coupled to the network 511, the stream playing device 520 is connected to the application server 503. The stream playing device 520 sends the device identifier code to the application server 503 and the application server 503 verifies that the device identifier code is associated with an account at 521. The stream playing device 520 is activated after the application server 503 confirms that the device identifier code is associated with the account at 522. The stream playing device 520 sends a request for a playback stream object at 523 whereby the request includes the device identifier code.

The application server 503 verifies at 523 that the device identifier code is associated with the account, incorporates the selected plurality of playback items into a playback stream object based on an incorporation criteria and the playback stream object is associated with the account. It will be appreciated that the incorporation criteria determines how the items are incorporated into the playback stream object and can include a random incorporation criteria, a sequential incorporation criteria, a counter generated incorporation criteria, and a manually generated incorporation criteria, or the like criteria.

The application server 503 streams the playback stream object to the stream playing device 520 for playback in an output device at 524. A counter may be set on the application server 503 to determine how the playback items may be incorporated into the playback stream object. The counter may be time based or unit based. The counter can represent a criteria whereby the account holder can determine how many times a particular item is played within an object based on a time period or the like. For example, the account holder may limit the number of plays of a particularly expensive item. If the counter is set to zero, steps 523 and 524 are repeated. Alternatively, the counter can represent a criteria whereby the account holder can determine the frequency that the stream playing device 130 checks for or fetches a new list from the server 120. For example, the counter may be set to 15 minutes where the stream playing device sends a request for a new list from the server 120.

It should be noted, that the playback stream object is protected because only the stream playing device 520 can receive and play content from the application server 503 based on the connection that is established between the device and the server. Additional protection may be achieved through addressing, network security and other measures that may be employed using encryption or the like. An advantage is the stream playing device 520 may be remotely administered by any input terminal connected to the internet. Through the website supported by the application server 503, a subscriber can administer or manage the playback items to be streamed to the stream playing device 520. Other parameters can be administered since the network infrastructure may vary on a country-by-country basis, or a network-by-network basis, or the like and information on the speed and distribution of the network may affect settings for content delivery.

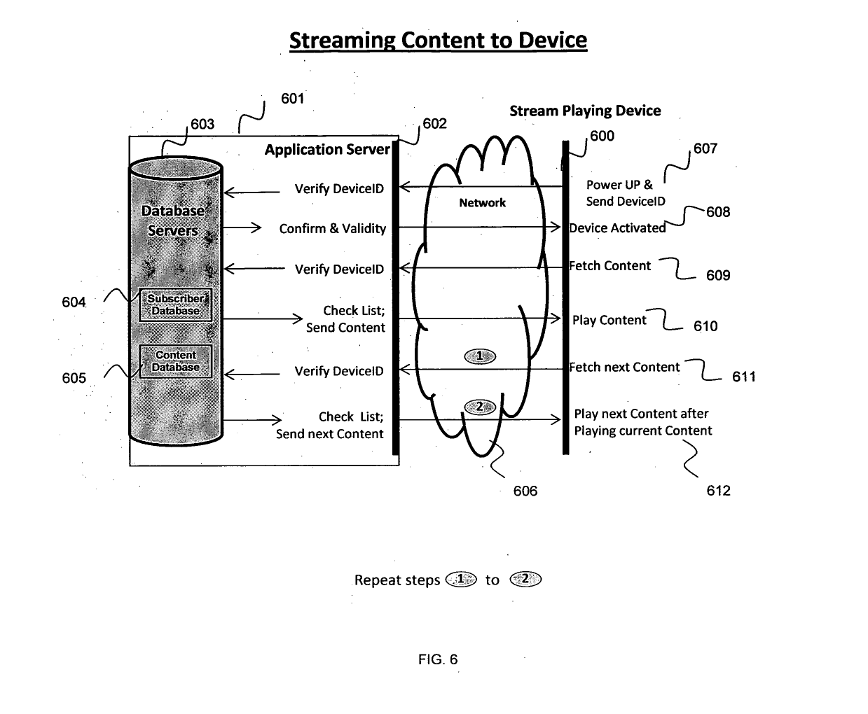

FIG. 6 is a process flow diagram illustrating an exemplary interaction between a stream playing device 600 and a content server 601 associated with content streaming over a network 606 in accordance with an embodiment. The content server 601 has an application server 602 coupled to the network 606, and a database server 603 coupled to the application server 602. The database server 603 may have a subscriber database 604 for storing information related to a subscriber and a content database 605 for storing digital content.

The interaction between the stream playing device 600 and the content server 601 includes the stream playing device 600 streaming one of the plurality of playback items in the playback stream object to an output device for playback in the output device at exchange 610 before the application server 602 has completed the transfer of the playback stream object. Specifically, the stream playing device requests for a next playback item in the playback stream object from the application server 602 at exchange 611. The application server 602 verifies that the device identifier code is associated with an account and sends the next playback item to the stream playing device 600 in exchange 612. The current or first playback item currently playing in the stream playing device 600 continues to play until the transfer of the next playback item to the stream playing device 600. As a result, the playback is continuous and the user listening or watching the playback item does not experience any interruptions or an incomplete playback. A counter may be set in the application server 602 such that if the counter is zero, exchanges 611 and 612 are repeated.

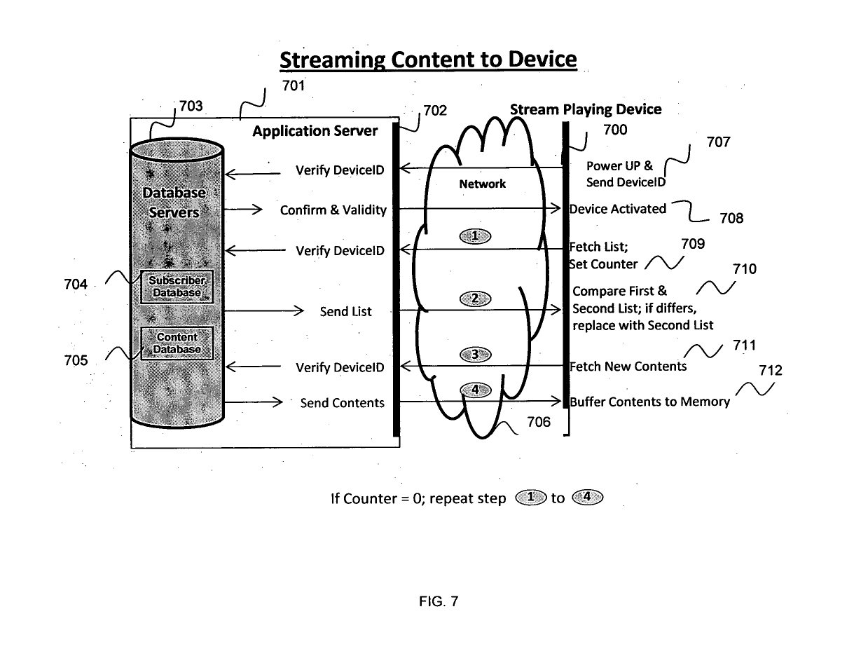

FIG. 7 is a process flow diagram illustrating an exemplary interaction between a stream playing device 700 and a content server 701 associated with content streaming over a network 706 in accordance with an embodiment. The content server 701 has an application server 702 coupled to the network 706, and a database server 703 coupled to the application server 702. The database server 703 may have a subscriber database 704 for storing information related to a subscriber and a content database 705 for storing digital content.

In exchange 709, the application server 702 verifies a device identifier code of the stream playing device 700 after receiving a request for a second list of playback items from the stream playing device 700, wherein the stream playing device 700 has a first list of playback items. In exchange 710, the application server 702 transfers the playback stream object including the second list to the stream playing device 700. The stream playing device 700 is configured to compare the first list and the second list at exchange 710 and the first list is replaced with the second list if one of the playback items in the second list is different from the playback items in the first list, i.e. a new playback item. Subsequently, the stream playing device 700 sends a request for the new playback item to the application server 702 which verifies that the device identifier code of the stream playing device 700 is associated with the account at exchange 711. In exchange 712, the application server 702 transfers the playback stream object including the new playback items constituted in the second list to the stream playing device 700. An advantage is that the streaming process is not repeated if the requested content is still in the buffer.

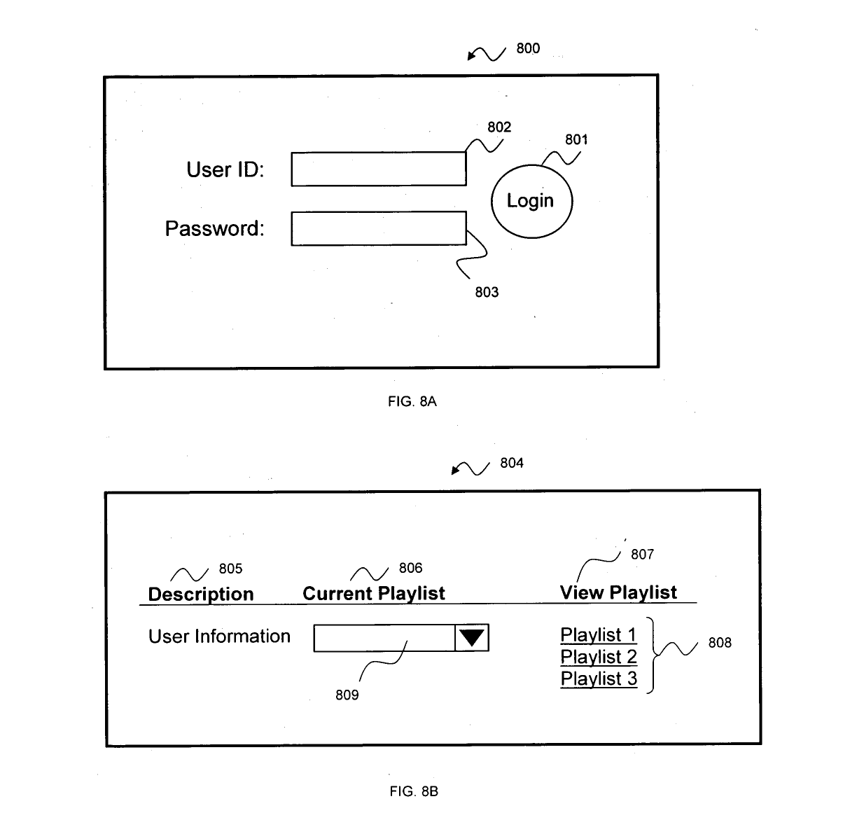

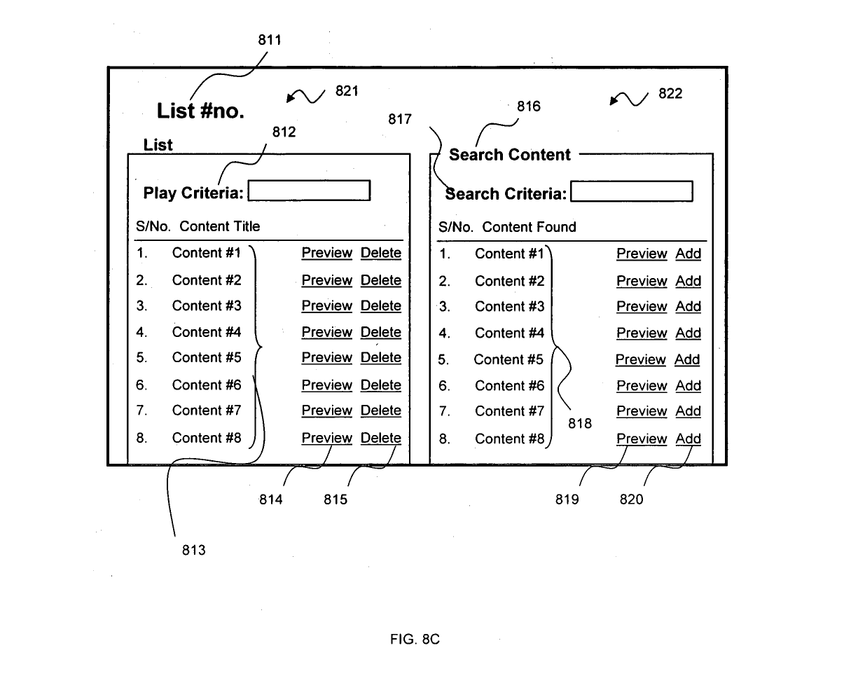

Referring now to FIG. 8A, a user interface 800 for accessing digital content on a server is described. The user interface 800 may be displayed on an input terminal so as to enable a subscriber having an account with a digital content service provided by the server to access the digital content on the server. For example, the user interface 800 has form fields to enable the entry of information associated with an account, such as a user ID form field 802 and a password form field 803. A login feature 801 is provided in the user interface 800 for the subscriber to submit the login request to the server.

Upon successful login by the subscriber to the server, a second user interface 804 is displayed in the input terminal as shown in FIG. 8B. In the second user interface 804, a description header 805 is provided that shows the information related to the subscriber, a current playlist header 806 which shows the list of playback items currently playing or streaming in the stream playing device. The second user interface 804 also has a view playlist header 807 which shows a plurality of lists 808, each list 808 having selected plurality of playback items. A subscriber may edit any of the plurality of lists 808 to delete or add playback items.

Referring to FIG. 8C where the subscriber selects a list 811 of playback items from the plurality of lists 808, the plurality of playback items 813 in the list 811 is displayed in a playback portfolio interface 821. The subscriber may then click on a preview button 814 to preview a playback item 813. The subscriber may also select a playback criteria by selecting from a list of playback criteria in the play criteria menu 812.

Further, the subscriber may also search for new playback items or new digital content stored on the server via a browser interface 822. In the browser interface 822, a search criteria menu 817 is provided where the subscriber may select to search for playback items or digital content stored in the server. After the search is completed, the searched playback items 818 are displayed on the browser interface 822. The subscriber may then click the preview button 819 to preview a playback item. To select a playback item, the subscriber may click on the add button 820 to add the playback item to the plurality of playback items in the list 811.

Whilst there has been described in the foregoing description preferred embodiments of the present invention, it will be understood by those skilled in the technology concerned that many variations or modifications in details of design or construction may be made without departing from the present invention.

1. A method for streaming digital content over a network from a content server to a stream playing device, the content server and the stream playing device connected to the network, the method comprising:
selecting a plurality of playback items located on the content server from an input terminal associated with an account, the input terminal coupled to the network, the input terminal different from the stream playing device, the plurality of playback items including digital content stored on the content server;
allocating copyright permissions to each of the plurality of playback items based on a parameter associated with the account; and
incorporating the selected plurality of playback items into a playback stream object based on an incorporation criteria, the playback stream object associated with the account.

2. The method according to claim 1, further comprising:
connecting the stream playing device and the server over the network and verifying that a device identifier code of the stream playing device is associated with the account; and
transferring the playback stream object including the plurality of playback items from the content server to the stream playing device if the device identifier code of the stream playing device is associated with the account.

3. The method according to claim 1, wherein the incorporation criteria includes one of: a random incorporation criteria; a sequential incorporation criteria; a manually generated incorporation criteria; and a counter generated incorporation criteria.

4. The method according to claim 1, wherein the parameter associated with the account includes one of: a subscription level associated with the account; a permission level associated with the account; and an individual royalty purchase associated with one of the plurality of playback items.

5. The method according to claim 1, wherein the allocating copyright permissions includes:
subscribing to a use of the digital content; and
allocating the copyright permissions to each of the plurality of playback items based on the subscribed use of the digital content, the copyright permissions including one of: performance, recording, and publishing rights of the digital content.

6. The method according to claim 5, wherein the subscribing to the use includes subscribing to one of a private use and a commercial use of the digital content.

7. The method according to claim 1, wherein the selecting a plurality of playback items includes:
accessing the content server from the input terminal through the network;
selecting the plurality of playback items from selectable playback items displayed on a user interface associated with the website.

8. The method according to claim 7, wherein the accessing includes accessing through: a website; a direct connection from the input terminal, an application running on the terminal, a message exchanging facility.

9. The method according to claim 1, wherein the access terminal includes remote terminal, a laptop computer, a cellular telephone, a portable digital assistant (PDA), a smartphone, and a reader.

10. The method according to claim 1, wherein:
the selected ones of the plurality of playback items constitutes a first list of playback items; and
the transferring the playback stream object includes transferring the playback stream object including the playback items constituted in the first list, the stream playing device storing the playback stream object.

11. The method according to claim 10, wherein:
the selecting the plurality of playback items includes one of: selecting a new at least one of the plurality of playback items; and deleting an existing at least one of the plurality of playback items;
the selected ones of the plurality of playback items including the one of the selected new at least one and the deleted existing at least one of the plurality of playback items constitutes a second list of playback items; and
the transferring the playback stream object includes transferring the playback stream object including the playback items constituted in the second list, the stream playing device storing the playback stream object.

12. The method according to claim 11, wherein the transferring the playback stream object includes:
transferring the playback stream object including the playback items constituted in the second list;
comparing the first list and the second list; and
one of storing and deleting one of at least portions of the playback stream object, the at least portions representing a difference, if any, between the first list and the second list.

13. The method according to claim 1, wherein the network includes one of a wired network and a wireless network.

14. The method according to claim 1, wherein the input terminal being different from the stream playing device includes the input terminal being at a different location from the stream playing device.

15. A stream playing device in a system for streaming digital content over a network from a content server, the content server and the stream playing device connected to the network, the stream playing device comprising:
a network interface coupled to the network; and
a controller coupled to the network interface, the controller including a buffer and a device identifier code capable of being associated with an account on the content server, the controller configured to:
connect with the server over the network interface and transfer the device identifier code; and
receive a playback stream object including a plurality of playback items from the content server if the device identifier code is associated with the account,
wherein each of the plurality of playback items are associated with copyright permissions allocated based on a parameter associated with the account.

16. The stream playing device according to claim 15, wherein the controller is further configured to decode the playback stream object and output the digital content to an output device based on the copyright permissions.

17. The stream playing device according to claim 16, wherein the controller is further configured to track a number of the plays of individual ones of the plurality of the playback items associated with the output of the digital content.

18. The stream playing device according to 15, wherein the output device includes one of an audio device, a visual device, and an audio-visual device.

19. The stream playing device according to claim 15, wherein one of the controller and the network interface are incorporated into an integrated circuit (IC).

20. The stream playing device according to claim 15, wherein one of the controller and the network interface are incorporated into a circuit board.

21. The stream playing device according to claims 19, wherein one of the IC and the circuit board are incorporated into a set top box.

22. The stream playing device according to claim 15, wherein the network includes one of a wired network and a wireless network.

23. A server for streaming digital content over a network to a stream playing device, the server and the stream playing device connected to the network, the server comprising:
a network interface configured to receive and send data over the network;
a storage device including a content database that stores digital content including playback items; and
a processor coupled to the network interface and the storage device, the processor configured to:
incorporate a selected plurality of the playback items into a playback stream object based on an incorporation criteria, the playback stream object associated with an account;
connect with the stream playing device over the network interface and receive a device identifier code from the stream playing device; and
transfer the playback stream object including the plurality of playback items to the stream playing device if the device identifier code is verified to be associated with the account,
wherein each of the plurality of playback items are associated with copyright permissions allocated based on a parameter associated with the account.

24. The server according to claim 23, further comprising a World Wide Web interface to which an input terminal associated with the account can make a connection over the network interface, the input terminal capable of selecting the plurality of playback items, the input terminal different from the server and the stream playing device.

25. The server according to claim 23, wherein the incorporation criteria includes one of: a random incorporation criteria; a sequential incorporation criteria; a manually generated incorporation criteria; and a counter generated criteria.

26. The server according to claim 23, wherein the parameter associated with the account includes one of: a subscription level associated with the account; a permission level associated with the account; and an individual royalty purchase associated with one of the plurality of playback items.

27. The server according to claim 23, wherein the copyright permissions are allocated based on a subscription to a use of the digital content,
wherein the copyright permissions including performance, recording, and publishing rights of the digital content.

28. The server according to claim 27, wherein the use includes one of a private use and a commercial use of the digital content.

29. The server according to claim 24, wherein the selected plurality of playback items includes ones of the playback items selected by:
accessing the content server from the input terminal through the network;
selecting the plurality of playback items from selectable playback items displayed on a user interface associated with the input terminal.

30. The server according to claim 29, wherein the accessing includes accessing through: a website; a direct connection from the input terminal, an application running on the terminal, a message exchanging facility.

31. The server according to claim 24 wherein the input terminal includes remote terminal, a laptop computer, a cellular telephone, a portable digital assistant (PDA), a smartphone, and a reader.

32. The server according to 24, wherein the selected ones of the plurality of playback items are constituted according to a first list, and wherein the playback stream object is transferred including the playback items constituted in the first list.

33. The server according to claim 32, wherein the selected ones of the plurality of playback items are constituted according to a second list of playback items the second list including one of a new at least one of the plurality of playback items and a deleted existing at least one of the plurality of playback items.

34. The server according to claim 33, wherein processor is further configured to transfer the playback stream object including the playback items constituted in the second list.

35. The server according to any of the above claims claim 24, wherein the network includes one of a wired network and a wireless network.

36. The server according to claim 24, wherein the input terminal being different from the stream playing device includes the input terminal being at a different location from the stream playing device.
